(19) United States
(12) Patent Application Publication
(10) Pub. No.: US 2009/0220919 A1
(43) Pub. Date: Sep. 3, 2009

(54) Dental Bleaching Gel Composition Containing Vegetative Enzymes

(76) Inventors: Jen-Chang Yang, Taipei City (TW); Yu-Lin Huang, Taichung County (TW); Hongda Wu, Yonghe City (TW); Yen Cheng Yang, Luodong Town (TW); Sheng-Yang Lee, Taipei City (TW)

Correspondence Address: AGNEW INTERNATIONAL;PATENT & TRADEMARK LAW FIRM, 7700 Irvine Center Drive, SUITE 800, Irvine, CA, 92618, US

(21) Appl. No.: 12/191,628

(22) Filed: Aug. 14, 2008

Related U.S. Application Data
(60) Provisional application No. 61/032,078, filed on Feb. 28, 2008.

(51) Int. Cl. A61C 17/00; A61Q 11/00

(52) U.S. Cl. 433/216; 424/53

(57) ABSTRACT

This invention is related to a kind of teeth bleaching formulation containing the vegetative enzymes extracted from plant tubers with extensively applications in cosmetic dentistry. The enzymes are susceptible to promote the decomposition (dissociation) of peroxide compounds, thus the intermediate hydroxyl free radicals are generated to turn the unpleasant stained tooth into light or colorless appearance effectively. The composition of a whitening gel may comprising 2˜50 wt % of hydrogen peroxide, 0.003˜3 wt % vegetative enzyme extract, and transferring to alkalinity approximately pH 8˜13 to achieve the high efficiency dental bleaching usage.

### CROSS REFERENCE TO RELATED APPLICATION

This application claims the benefit of priority under 35 U.S.C. 119(e) to the filing date of U.S. provisional patent application No. 61/032,078 entitled “A dental bleaching gel containing extracted vegetative enzymes” which was filed Feb. 28, 2008, and is incorporated herein by reference.

### FIELD OF THE INVENTION

The present invention relates to a dental bleaching gel composition, and more particularly, to a dental bleaching gel composition containing vegetative enzymes extracted from plant tubers where such vegetative enzymes have excellent activities of promoting and accelerating the dissociation of hydrogen peroxide and thereby beneficially releasing increased quantity of intermediate derivate (i.e. free radical of hydroxyl peroxide) within certain unit time interval such that the organic stain or pigment associates with the teeth can be reduced as a result of the oxidation and thus enhancing the pleasant appearance.

The functioning mechanism of catalyzing hydrogen peroxide by means of vegetative enzymes extracted from plant tubers can be widely applied to a variety of fields and cosmetic industry. More importantly, because of the increased bleaching efficiency, the basic requirements of in-office bleaching process can be achieved within a short period of time, resulting a reduction of disadvantageous side-effects, such as 1) enamel erosion, 2) damages and discomfort to the oral tissues, 3) sensitive sour and pain after treatment etc, and 4) other disadvantages associated with using bleaching gel containing high concentration of hydrogen peroxide. Accordingly, a novel dental bleaching gel composition capable of reducing treating period is therefore provided.

### BACKGROUND OF THE INVENTION

It has been widely established that whitened and aesthetic teeth gives an appealing appearance, increased self-confidence that promotes social relationship. As a result, teeth bleaching have become very popular. The causes which result stains shown on the teeth are complicated, and many resources can attribute to those strains. For examples, stains caused by pigment and residual deposit around the crown area as a result of drinking tea and coffee, smoking, and areca-chewing are referred to as extrinsic stains. Extrinsic stain can be removed through hygienic bleaching process. On the other hand, intrinsic stains are discolored teeth caused by oral ingestion of tetracycline related medicine or by oral ingestion of excessive dosage of fluoride. Intrinsic stain can not be whitened through general hygienic bleaching but rather be improved and whitened through bleaching process.

The existing teeth whitening process can be categorized into at-home and in-office. For the at-home treatment, the patient administers a certain dosage of bleaching gel which contains a concentration of 4˜6 wt % of hydrogen peroxide based on total weight of the formulation or a concentration of 10˜15 wt % carbamide peroxide based on total weight of the formulation into a teeth tray where the teeth tray is then placed inside the mouth and adjacent to the crown. A typical treatment session lasts thirty to sixty minutes. Because the concentration of the hydrogen peroxide or carbamide peroxide is comparably low, the treatment will typically takes one to two weeks to achieve its intended result.

Given the extended duration required, the patient needs a great deal of patience during the treatment. Further, care has to be extremely taken so as not to irritate the gum tissues around the teeth. On the other hand, the bleaching gel or paste used in in-office, which is also referred to as power bleaching or chairside bleaching, contains high concentration of hydrogen peroxide, generally from 25˜35% based on total weight of the formulation. In application, after the bleaching gel or paste is administered around the crown, additional light or heat source need to be applied so as to promote and accelerate the dissociation of the hydrogen peroxide, releasing free radical of hydroxyl peroxide. Accordingly, the pigment residual and stains deposited on the surface of teeth can effectively be dissociated and removed.

U.S. Pat. No. 5,290,566 issued to Schow et al on Mar. 1, 1994 discloses a tooth whitening formulation in the form of a gelling agent comprising urea/hydrogen peroxide (1:1) in a concentration of 22-32 wt % based on the total weight of the formulation, and a thickener of methylcellulose.

U.S. Pat. No. 5,631,000 issued to Pellico et al on May 20, 1997 discloses an anhydrous dental bleaching gel composition embodying features comprising propylene glycol, polyethylene glycol, glycerin so as to stabilize the bleaching agent replacing the traditional thickened solution. In addition, the shelf life of the hydrogen peroxide can also be prolonged.

On the other hand, U.S. Pat. No. 6,447,757 issued to Orlowski et al on Sep. 10, 2002 discloses compositions offering extended shelf life and accelerated bleaching action it features one part of the composition comprising peroxides of monovalent or bivalent metals replacing the traditional hydrogen peroxide, and another part comprising an aqueous solution of one or more acids able to convert said metal peroxides into hydrogen peroxide.

U.S. Pat. No. 5,928,628 issued to Pellico et al on Jul. 27, 1999 discloses a two-component dental bleaching system. In application, one component which comprises a dental peroxide gel having a pH from about 4 to about 7 is mixed with the other component comprising an orally compatible alkaline gel having a pH from about 9 to about 13. The mixing of the components provides for a dental bleaching gel having a pH from about 8.5 to about 11, thereby increasing the rate of releasing active oxygen and accelerating the bleaching action.

U.S. Pat. No. 6,908,627 issued to Banerjee et al on Jun. 21, 2005 discloses a dental bleaching gel composition having a concentration of 35% of hydrogen peroxide based in total weight of the formulation with a pH less than 7. Catalase from Escherichia coli, catalase occurring in liver cell, peroxide, dopamine-hydroxylase, and peptide glycine-hydroxylase, can be combined to be an effective dental bleaching gel.

A tooth is configured by dentine and enamel which encloses the dentine. The composition of enamel includes 96% of hydroxyapatite, and 4% of collagen, while the dentine is composed by 70% of inorganic substance, 30% of organic substance and water. Since the free radical of hydroxyl peroxide (.OH) will destroy molecules of protein, while acid ion (H⁺) will erode the inorganic substance, Pearson in his 1958 publication stated that during the bleaching process, the hydrogen peroxide will infiltrate into the pulp through the enamel and dentine. As a result, the pulp will be damaged. In addition, discomfort and sourness will always associate with patient who suffers from sensitive teeth. Generally, it takes about 40 to 60 minutes to complete a typical bleaching process. The higher the concentration of the hydrogen peroxide, the acidity associated therewith will inevitably erode the enamel, causing micro-pore across the surface of the crown. As a result, those micro-pores will further host pigments and stains which then in turns compromise the purpose of the bleaching process.

### OBJECT OF THE INVENTION

It is the object of the present invention to provide an improvement over the defects encountered by the existing bleaching formulation and method.

It is the object of the present invention to provide an improvement over the existing over the counter bleaching system and method.

It is further an object of the present invention to provide an improvement over the existing in-office bleaching system used by dentists.

It is further an object of the present invention to provide a teeth bleaching formulation containing the vegetative enzymes extracted from plant tubers with extensively applications in cosmetic dentistry.

### SUMMARY OF INVENTION

The functioning mechanism for teeth bleaching is by utilization of free radical hydroxyl peroxide released from dissociation of hydrogen peroxide and carbamide peroxide (H₂O₂→H₂O.+O.), which is later infiltrated into the enamel and destine of the teeth so as to create an oxidation process. During the oxidation process caused by the free radical, the teeth undergo a series of oxidation caused by the non-pair electrons of the free radical. Those free radicals will react with those organic colorful stains, reacting with non-saturated-valent or breaking down the carbon ring of the pigment. As a result, it changes and enhances the energy-absorbing capability of the organic compound, therefore providing a teeth bleaching effect by making the appearance of the teeth lighter and brighter as more energy can be absorbed. For the power bleaching process, which is normally conducted in-office, a variety of photo initiators are added into the bleaching gel or agent. The dissociation of the free radical of hydroxyl peroxide from this power bleaching gel or agent can be accelerated and excited by a light source with a predetermined wavelength, or by increasing its working temperature. Accordingly, the overall bleaching process can be therefore shortened.

The activation energy is critical to an intended chemical reaction during the course of activation reaction. In order to initiate the reaction, there is threshold energy necessary for the reactant molecules to overcome such that the reaction can be activated, and brings about the product from the reaction of the reactant molecules. It is well known that enzyme added to the reactant molecules can reduce the needed level of activation energy while increasing the efficiency of the chemical reaction. It has been found that plant tubers, such as potato, yam (Dioscorea alata), sweet potato contains a plurality of anti-oxidant molecules, i.e. polyphenol peroxidase, peroxidase (PO), catalase (CAT), superoxide dismutase (SOD) etc. According to the present invention, potato extract antioxidant (PEA) is added to the hydrogen peroxide so as to reduce its high activation energy of the hydrogen peroxide, (i.e. 71 kJ/ mole). As a result of the addition of the enzyme from the PEA, the activation energy is largely reduced while the chemical reaction of releasing free radical of hydroxyl peroxide remained unaltered. By this arrangement, a large quantity of free radical of hydroxyl peroxide can be released from the dissociation of hydrogen peroxide within a shorter period of time, thereby reducing the time required for bleaching process. This will reduce the possibility of creating micro-pore across the surface of the enamel reducing the possibility that the stain or pigment will deposit into those micro-pore within a certain period of time after bleaching.

It is the object of the present invention to solve the problem encountered by the existing prior art. When the antioxidant enzymes extracted from plant tuber is added to the hydrogen peroxide, the activation energy for dissociation of the hydrogen peroxide can effectively be reduced under the alkaline environment. An increased quantity of free radical of hydroxyl peroxide can be released from dissociation of hydrogen peroxide without the addition of the light or heat to excite the process. The present invention provides a safe while potent bleaching agent, softening the acidic erosion across the surface of the enamel resulted from micro-poring. The possibility of stain or pigment depositing into the micro-pore is thereby reduced.

Accordingly, a dental bleaching system is disclosed comprising a first component comprising a peroxide and a peroxide compatible gel compound; a second component comprising an anti-oxidant catalase and an anti-oxidant stabilizer; wherein the first and the second components are mixed. In one embodiment, the anti-oxidant catalase is extracted from plant tubers. In another embodiment, the dental bleaching system has a pH about 8 or higher. In yet another embodiment, the dental bleaching system where the pH of the first component is between 7 to 11 and the pH value of the second component is between 5 to 7. In yet one other embodiment, the peroxide is selected from a group consisting of a hydrogen peroxide, an organic peroxide, a compound which generates hydrogen peroxide, and combination thereof.

In yet another embodiment, the dental bleaching system of claim 1, wherein the peroxide compatible compound gel is Pluronic F-127. In yet another embodiment, the plant tubers is selected from a group consisting of potato, sweet potato, yam, taro and derivate species. In yet one other embodiment, the anti-oxidant catalase is a vegetative enzymes extracted from plant tubers. In one other embodiment, the vegetative enzymes extracted from plant tubers is a potato extract antioxidant. Here, the plant tubers can be selected from a group consisting of potato, sweet potato, yam, taro and derivate species.

In yet one other embodiment, the anti-oxidant catalase stabilizer is selected from a group consisting of NaN3 (sodium azide), EDTA, EGTA, DTT (dithiothreitol), β-ME (β-Mercaptoethanol)), BSA (bovine serum albumin), (Tween-20, Triton X-100), Glycerol, glucose, urea, PMSF (phenylmethylsulfonyl fluoride), TPCK, TLCK and benzamidine; wherein the anti-oxidant catalase stabilizer is capable of stabilizing or maintaining activity of the enzymes.

In one other aspect of the invention, a method to bleach mammal's teeth is disclosed which comprises a. providing a first component comprising a peroxide and a peroxide compatible gel compound; b. providing a second component comprising an anti-oxidant catalase and an anti-oxidant stabilizer; c. mixing the first component and the second component resulting a combined component; and d. applying the combined component to a mammal's teeth.

On one another embodiment, the anti-oxidant catalase is extracted from plant tubers. In yet another embodiment, the combined component as referred above has a pH of 8 or higher. In one other embodiment, the first component has a pH of between 7 to 11 and the second component has a pH of between 5 to 7. In yet another embodiment, the peroxide is selected from a group consisting of a hydrogen peroxide, an organic peroxide, a compound which generates hydrogen peroxide, and combination thereof. In yet one other embodiment, the peroxide compatible compound gel is Pluronic F-127.

In one embodiment, the plant tubers are selected from a group consisting of potato, sweet potato, yam, taro and derivate species. In one other embodiment, the anti-oxidant catalase is a vegetative enzyme extracted from plant tubers. In yet another embodiment, the vegetative enzymes extracted from plant tubers is a potato extract antioxidant. In yet one other embodiment, the plant tubers is selected from a group consisting of potato, sweet potato, yam, taro and derivate species. In yet a preferred embodiment, the anti-oxidant catalase stabilizer is selected from a group consisting of NaN3 (sodium azide), EDTA, EGTA, DTT (dithiothreitol), β-ME (β-Mercaptoethanol)), BSA (bovine serum albumin), (Tween-20, Triton X-100), Glycerol, glucose, urea, PMSF (phenylmethylsulfonyl fluoride), TPCK, TLCK and benzamidine; wherein the anti-oxidant catalase stabilizer is capable of stabilizing or maintaining activity of the enzymes.

### DETAILED DESCRIPTION

In order to improve and reduce the side effects and defects of damaging oral tissues, where advantages are a result of using the tooth bleaching agent containing high concentration of hydrogen peroxide over a prolonged period of treating time, it is an object of the present invention to provide a new formula or composition of tooth bleaching agent which increases the bleaching efficiency while reducing the concentration of the hydrogen peroxide with accelerated dissociation of the hydrogen peroxide. Under such a condition, when using the tooth bleaching agent containing a high concentration of hydrogen peroxide, (i.e. a concentration of 35% hydrogen peroxide based on total weight of the formulation), to whiten the teeth, the treating time can be effectively shortened thereby reducing the exposure of oral tissues under the bleaching agent; or alternatively, based on the same treating time, such as forty (40) minutes currently, the concentration of hydrogen peroxide can be reduced thereby reducing the prolonged exposure to the acidity of the hydrogen peroxide.

### A. Determination of Antioxidant Activity of Potato, Sweet Potato and Yam

### EXAMPLE 1

### Extracting Enzymes from Potato and Determination of Activity of Extracted Enzymes

Two hundreds (200) g of potato is prepared after peeling and cut into cubes. The potato cubes are then disposed into a blender, MJ-W171P, made by Panasonic, Japan, so as to collect about one hundred (100) ml of potato concentrate. Debris and fibers from the potato concentrate are filtered out. The potato concentrate is further disposed into a centrifuge to process at two thousand (2000) rpm about twenty (20) minutes under four (4) degrees Celsius. The clear liquid collected is the potato extract antioxidant (PEA). The PEA is then kept in a refrigerator under four (4) degrees Celsius.

The Unit Activity of the enzymes from tubes plant is defined by the exhaustion of the amount (μmole) of hydrogen peroxide per minute, μmole H₂O₂/min/g of plant, and which is determined by the following steps.

Taking one (1) ml of PEA and blended with twenty-eight (28) ml of PBS (100 mM) and one (1) ml of hydrogen peroxide (1 M) so as to create a solution of thirty (30) ml. Taking three (3) ml of blended solution, and put it into a quartz cell. The quartz cell is then placed into a spectrophotometer, (UV/Vis U-2010 Spectrophotometer, made by Hitachi, Japan), setting a wavelength of 240 nm, scanning time is six hundred (600) seconds so as to detect the absorbance of the blended solution. After the scanning process, variation of the absorbance per minute (ΔABS/min) is measured. Based on the pre-established equation of Y=0.0556 X+0.0431 for the concentration of hydrogen peroxide-ABS, where Y-axis representing ABS, X representing mole number (R²=0.995) of hydrogen peroxide, the exhaustion of hydrogen peroxide can be readily determined, and the activation energy of the PEA can be accordingly measured, the result is listed in Table 1.

### EXAMPLES 2 & 3

### Enzymes Extraction and the Determination of Enzymes Activity

Taking sweet potato and yam, which are also tubes plant such as potato, and repeating the processes as described above to firstly collect sweet potato extract antioxidant and yam extract antioxidant. The extracts are then stored in refrigerator under four (4) degrees Celsius. The Unit Activity is then measured based on the same procedures, and the results are entered into Table 1.

TABLE 1
Antioxidant Activity of Potato, Sweet Potato and Yam

| | Example 1 | Example 2 | Example 3 |
|---|---|---|---|
| Tube Plants | Potato | Sweet potato | Yam |
| ΔABS/min | 0.127 | 0.0021 | 0.35 |
| Unit Activity (μmole | 2.09 | 0.00245 | 0.23 |
| H₂O₂/min/g of plant) | | | |

### B. Relationship Between Concentration of Hydrogen Peroxide and Its Dissociating Time Under Different pH Values

### Control Groups 1 & 2: Concentration Effect of Hydrogen Peroxide

According to its bleaching mechanism, the hydroxyl free radicals accompanied by dissociation of the hydrogen peroxide is the key agent to oxidize and whiten the organic colored stains. Accordingly, the quantity of hydroxyl free radicals should be proportional to the rate of dissociation of the hydrogen peroxide. As a result, in developing the formula and composition of the bleaching agent, the potassium permanganate assay can be used as a calibration of the concentration of the hydrogen peroxide. The speed of the change of the variation of the concentration of the hydrogen peroxide over a period of time can be readily measured. The result can be used as a reference for later selection. Regarding to the test of variation of the concentration for the hydrogen peroxide, with a concentration of 35% based on total weight of the formulation, under different acidic and alkaline environments, such as in Control group 1, at pH 2; and Control group 2, at pH 9, see also U.S. Pat. No. 5,928,628 (1999), the pH value is adjusted such that the reaction is undergone under alkaline environment), samples for testing are taken under different concentration of the hydrogen peroxide over a period of time. The samples are taken according to the proportions listed in Table 2, and each ingredient is added according to a pre-determined order, and blended evenly. Samples are taken after the time interval of two (2), five (5), ten (10), twenty (20), and forty (40) minutes. Calibration of the concentration of the hydrogen peroxide is determined according to the following procedures.

Measuring one (1) gram of whitening gel and disposing it into a beaker, and then pouring in twenty (20) ml of de-ionized water and twenty (20) ml of sulfuric acid of a concentration of 2N, fully stir and blend the sample to completely dissolve the sample. Then dipping the potassium permanganate into a burette, and then adding the potassium permanganate into the beaker till the sample turns into pink. Measure the dosage of the potassium permanganate used, and then conduct a calculation according to the following equation.

$$\% {H}_{2} {O}_{2} = \frac{1.701 ( {H}_{2} {O}_{2} conversion factor ) \times {KMnO}_{4} ( ml ) \times 0.1 N}{Gel weight ( g )}$$

Repeating three times of the procedures described above, and found that the result is within 0.2 wt %. Averaging the results, and enter them into Table 2.

### EXAMPLES 4-6

### Relationship Between Concentration of Hydrogen Peroxide and Its Dissociating Time Under Different pH Values

In order to determine the effect of the addition of the PEA to the concentration of hydrogen peroxide under different pH values, hydrogen peroxide of 35 wt % were sampled and added with sodium peroxide (NaOH) such that the pH value reaches to pH 2 (Example 4), pH 7 (Example 5), and pH 9 (Example 6, in Example 6a, sodium peroxide was added firstly, and then PEA was added; in Example 6b, PEA was added firstly, and then sodium peroxide. By doing so, difference and variation between these two samples will be recorded and analyzed.) Afterward, taking 0.1146 gram of PEA from Example 1, and then fully mix it with Examples 4, 5, and 6. Then taking samples to measure at an time interval of two (2), five (5), ten (10), twenty (20), and forty (40) minutes, respectively. The calibration of the concentration of the hydrogen peroxide is again determined by potassium permanganate assay as used in Example 1. The results are then entered into Table 2.

From the results of Examples 4˜6, it is observed that the PEA does not have an apparent promoted effect in dissociating the hydrogen peroxide with 35 wt % under pH 2 and pH 7. Those results are quite similar to what reached in Example 1. However, it is observed that the PEA have an dominant effect in promoting and accelerating the dissociation of the hydrogen peroxide of 35 wt %, and which is apparent different from what taught from U.S. Pat. No. 6,908,607 (2005) issued to Banerjee et al. Banerjee discloses the bleaching gel has to be used under an environment with pH value not more than seven (7). Perhaps the difference in the property is resulted from the antioxidant extracted from tubes plant differ what extracted from animal liver or bacteria.

From the results of Examples 6(a) and 6(b), it is observed that the dissociation of hydrogen peroxide is proportional to whether sodium peroxide or PEA is first added into the sample. It is noted that the dissociation of the hydrogen peroxide can be promoted and accelerated when sodium peroxide is firstly added into the sample such that the sample with 35 wt % of hydrogen peroxide become alkaline-based, and then the PEA is added to accelerate the dissociation.

According to the teaching and suggestion from U.S. Pat. No. 5,928,628 (1999) issued to Pellico et al., it is noted that the dissociation of the hydrogen peroxide is faster under an environment of pH 9 (Control group 2), which is alkaline environment, then pH 2 (Control group 1), which is acidic environment. On the other hand, if we compare the result from Control group 2 and Example 6(b), it is noted that the dissociation rate has apparently increased in Example 6(b), while is still slower than 6(a). This result is surprising and unexpected. From this observation, it is noted that it seems that the activity of PEA may lose its activity under acidic environment; thereby PEA is not able to promote and accelerate the dissociation of hydrogen peroxide under acidic environment.

TABLE 2
Relationship between concentration of hydrogen peroxide and its dissociating time
under different pH values

| | | Control group 1 | Control group 2 | Example 4 | Example 5 | Example 6 (a) | Example 6 (b) |
|---|---|---|---|---|---|---|---|
| Composition | | | | | | | |
| 35 wt % H₂O₂ (g) | | 11.35 | 11.35 | 11.35 | 11.35 | 11.35 | 11.35 |
| NaOH (g) | | | 0.6240 | | 0.0019 | 0.6240 | |
| PEA (g) | | | | 0.1146 | 0.1146 | 0.1146 | 0.1146 |
| NaOH (g) | | | | | | | 0.6240 |
| pH | | 2 | 9 | 2 | 7 | 9 | 9 |
| Dissociation | | | | | | | |
| H₂O₂ | 0 min | 35.00 | 35.00 | 35.00 | 35.00 | 35.00 | 35.00 |
| (%) | 2 min | 36.23 | | 35.04 | 35.00 | 33.34 | 34.50 |
| | 5 min | 36.23 | 28.00 | 34.28 | 35.00 | 29.90 | 34.00 |
| | 10 min | 36.23 | 25.00 | 35.47 | 34.53 | 7.23 | 33.35 |
| | 20 min | 35.55 | 25.50 | 35.21 | 35.13 | 8.93 | 25.00 |
| | 40 min | 35.13 | 21.50 | 35.21 | 35.38 | 7.65 | 23.74 |

### C. Evaluation of Bleaching Agent Based on Different Compositions and Operating Conditions on External Teeth

### Control Group 3(a) and Control Group 3(b): Evaluation of Whitening Effect of Market-Available Bleaching Gel on External Teeth

The control group of bleaching agent is selected from the market-available Everbrite™, containing 35 wt % of hydrogen peroxide with a whitening power as photoinitiator, and uses Plasma Arc Light (LITEX™ 685, Dentamerica, Calif., USA) with wavelength of 400˜500 nm as light source. The experiments are divided into under exposure (Control group 3(a)), and non-exposure (Control group 3(b)).

### Evaluation Procedures for Bleaching Agent on External Teeth

Teeth are collected from clinic surgery and which are pulled from patient because of orthodontic correction, gum disease, or non-functional wisdom teeth and rear teeth. The tooth surface should be free from any artificial crown, fills, visible decalcification, cracks, or defects. After the tooth is pulled from the patient, the teeth are stored in saline water under refrigerator of four (4) degree Celsius.

The sampled tooth is processed to remove any loose surfaces by knife. The surface is then polished for ten (10) seconds with pumice power and rubber cup under low rotational speed, and then clearing the surface with running water. Then, the crown is then cut off from the cementoenamel junction (CEJ), to separate remove the root from 2 mm thereunder. The crown will be used for experiment.

Standardized artificially staining process on teeth can be referred to the process established by Sulieman M. A tea bag (2 grams) of Ceylon tea, Ranfer Tea LTD, Colombo, Sir Lanka, was put into one hundred (100) ml of boiling de-ionized water for five (5) minutes, and then cooled down to room temperature (22±2 □). The tooth is then disposed within the tea for staining twenty-four (24) hours. The tooth is then taken out, and leave under an environment of 100% humidity at temperature of thirty-seven degrees Celsius (37 □) for later use.

The Everbrite™ bleaching gel is used according its instruction. Photoinitator power is blended with two (2) ml of hydrogen peroxide into paste. Then the paste is covered onto each of the sample tooth. Each group contains five (5) teeth, i.e. n=5. For the samples to be exposed to light in Control group 3(a), a light from 2.8 W Plasma Arc Light is alternatively turned on for thirty (30) seconds, and then turned off for five (5) seconds for totally fifteen (15) cycles. Each fifteen-cycle take about ten (10) minutes, and totally four (4) fifteen-cycle were performed. For the sampling teeth under Control group 3(b), they sit under room temperature for forty (40) minutes. After that, the teeth are washed with purified water and have it dried naturally.

Before each of the tooth is evaluated with its whiteness, the stained tooth is each measured by a spectrophotometer, SCM-104, Laiko Co, LTD, Japan, with C light source at ten (10) degrees. This would be the basic condition for testing. Each tooth is measured with its tri-stimulus values, and X, Y, and Z are taken as referential value. Then, the spectrophotometer, SCM-104, is used to measure the L*a*b* of each sample tooth after bleaching process. The value of L*a*b* is calculated from the following equations.

L*=116(Y/Yn)^{1/3}−16

a*=500[(X/Xn)^{1/3}−(Y/Yn)^{1/3}]

b*=200[(Y/Yn)^{1/3}−(Z/Zn)^{1/3}]

Xn, Yn, Zn are reference white value.

According to CIE L*a* b* Color System, the color difference (□E) is calculated based on the following equation.

ΔE=[(L*₁−L*₂)²+(a*₁−a*₂)²+(b*₁b*₂)²]^{1/2}

The color difference before and after bleaching process is taken as an index to evaluate the whiteness after bleaching process. The larger the color difference value, the better the bleaching result. The results are entered into Table 3. The results reveal that on the evaluation of the bleaching agent Everbrite™, the color difference (ΔE) for Control group 3(a) is 6.81±1.45, which is higher than the color difference (ΔE) for Control group 3(b), which is 5.28±1.57.

### EXAMPLE 7

### Time Factor in the External Bleaching Process

The bleaching gel or agent used in this experiment is 11.35 grams of hydrogen peroxide of 35 wt % blended with two (2) grams of thickening, Pluronic F-127. The mixture is then blended with a magnetic stirrer under vacuum environment for ten (10) minutes so as to create a paste. Afterword, point six-two (0.62) grams of solidified sodium peroxide is added into the paste and stirred evenly (pH 9). After adding 0.1146 gram of PEA from Example 1 into the paste, stir again with a magnetic stirrer. Afterward, deploying the bleaching paste over the sample tooth, and leave it under room temperature for five (5) minutes for Example 7(a); ten (10) minutes for Example 7(b); forty (40) minutes for Example 7(c); and forty (40) minutes for Example 7(d), and which is also exposed under light source. After the time elapses, each sample tooth is washed and dried naturally. Once again, the spectrometer used in Reference 3 is used to measure the color difference (ΔE*), which an index to evaluate the whiteness after bleaching process, based on the CIE L*a*b* color system with the same procedures. The results are then entered into Table 3.

The result reveals that bleaching agent made from the hydrogen peroxide of 35 wt % with PEA of 1 wt % will bring about a color difference (ΔE) of 3.86±0.57; 9.76±0.57; and 11.22±4.37, respectively, for five (5), ten (10), and forty (40) minutes bleaching time periods, under an alkaline environment of pH 9. As compared to the market available Everbrite™, which brought about a color difference (ΔE) of 6.81±1.45 after a bleaching of forty (40) minutes, the PEA of 1 wt % effectively reduces and cut ten (10) or more minutes. On the other hand, the sample tooth with the same bleaching agent, one under light exposure and one not for forty (40) minutes, the results show there is no statistic difference to their color differential (ΔE), 11.37±4.54 for Example 7(d), and 11.22±4.37 for Example 7(c), respectively.

### EXAMPLE 8

### Evaluation of Bleaching Agent Having Low Concentration on External Teeth

In this experiment, the original 35 wt % hydrogen peroxide has been replaced by 6 wt % hydrogen peroxide, while the procedures remain the same when evaluate the whitening effect administered to the external teeth. The results are entered into Table 3.

The result reveals that when the PEA of 1 wt % was added into the hydrogen peroxide of 6 wt %, under the pH 9 environment, without exposure to light source, and after forth (40) minutes of bleaching time, the color difference (ΔE) is 4.95±1.41, which is slightly lower than the Control group 3(a), which has a color difference (ΔE) of 6.81±1.45, and the bleaching agent used therein is Everbrite™, and exposed under light source. While compared to the Control group 3(b), in which the sample tooth was not under light source, their color difference (ΛE) values were both around 5.28±1.57, no statistical difference. This result is surprising and unexpected.

TABLE 3
Evaluation of bleaching agent based on different compositions and
operating conditions on external teeth

| | Control group | Control group | | | | | |
|---|---|---|---|---|---|---|---|
| | 3(a) | 3(b) | Example 7(a) | Example 7(b) | Example 7(c) | Example 7(d) | Example 8 |
| Composition | | | | | | | |
| H₂O₂ (wt %) | 35 | 35 | 35 | 35 | 35 | 35 | 6 |
| H₂O₂ (g) | | | 11.35 | 11.35 | 11.35 | 11.35 | 10.14 |
| PF-127 (g) | | | 2.00 | 2.00 | 2.00 | 2.00 | 1.79 |
| NaOH (g) | | | 0.62 | 0.62 | 0.62 | 0.62 | 0.01 |
| PEA (g) | | | 0.11 | 0.11 | 0.11 | 0.11 | 0.10 |
| Operating | | | | | | | |
| Conditions | | | | | | | |
| Light Source | On | Off | Off | Off | Off | On | Off |
| Bleaching Time | 40 | 40 | 5 | 10 | 40 | 40 | 40 |
| (min) | | | | | | | |
| Before Bleaching | | | | | | | |
| X | 28.59 ± 6.32 | 32.93 ± 5.61 | 24.05 ± 4.13 | 22.58 ± 1.84 | 24.96 ± 2.95 | 25.52 ± 2.25 | 25.50 ± 5.36 |
| Y | 29.49 ± 6.59 | 33.90 ± 5.81 | 24.82 ± 4.27 | 23.36 ± 1.86 | 25.63 ± 3.27 | 26.24 ± 2.41 | 26.39 ± 5.75 |
| Z | 29.53 ± 7.27 | 33.15 ± 5.86 | 25.94 ± 4.63 | 24.20 ± 1.90 | 24.15 ± 4.05 | 26.76 ± 3.46 | 27.83 ± 7.33 |
| After Bleaching | | | | | | | |
| L* | 62.57 ± 3.42 | 61.05 ± 3.94 | 59.82 ± 4.53 | 64.15 ± 1.38 | 67.10 ± 3.85 | 68.06 ± 4.30 | 62.81 ± 4.23 |
| a* | −0.89 ± 0.55 | −0.74 ± 0.53 | −0.76 ± 0.24 | −1.60 ± 0.89 | −1.01 ± 0.83 | −1.14 ± 0.55 | −1.46 ± 0.76 |
| b* | 0.41 ± 0.36 | 4.52 ± 1.12 | 2.36 ± 2.15 | 1.19 ± 1.47 | 0.49 ± 3.31 | 0.07 ± 1.62 | 3.36 ± 2.55 |
| Color Difference | 6.81 ± 1.45 | 5.28 ± 1.57 | 3.86 ± 0.57 | 9.76 ± 0.57 | 11.22 ± 4.37 | 11.37 ± 4.54 | 4.95 ± 1.41 |
| ΔE* | | | | | | | |

### D: Evaluation of Whitening Effect When the Photocatalys is Used on the Bleaching Process of External Teeth

Control Group 4(a)/4(b): Evaluation of Bleaching Agent on External Teeth with Photocatalyst

On year 2002, Toru Nonami of Japan included titanium dioxide (TiO₂), photocatalast, of concentration less than 1 wt % into hydrogen peroxide, along with light source of wavelength 380˜420 nm and power 400 mW/cm² for twenty (20) minutes. The result reveals that the hydrogen peroxide of 3.5 wt % is accelerated by the titanium dioxide, and it brings an excellent bleaching and whitening result. The bleaching agent used in Control group 4 follows Nonami teaching, and includes 0.05 gram of the photocatalyst of titanium dioxide, Degussa-P25, along with 10.14 grams of hydrogen peroxide of 6 wt %, plus 0.1 gram of ferric oxide, and 2.00 grams of thickening, Pluronic F-127. These ingredients were mixed with a magnetic stirrer under vacuum environment into a paste. Then the paste is applied to the sample teeth following the procedures as performed in Control group 4(a), in which the sample tooth is exposed to a light source; and Control group 4(b) in which the sample teeth exposed no light source. The bleaching process lasts for forty (40) minutes, and the results were entered into Table 4.

The result reveals that when titanium dioxide of 1 wt % is added into hydrogen peroxide of 3.5 wt %, the sample tooth in Control group 4(a), in which light source is used, shows a color difference (ΔE) of 4.51±2.54; while the sample tooth in Control group 4(b), in which no light source is used, shows a color difference (ΔE) of 2.65±0.53, which is apparently lower than Control group 4(a). However, the overall whitening effect is slight lower than Everbrite™, see Control group 3(a).

### EXAMPLE 9(a)/9(b)

### Evaluation of Whitening Effect When the Photocatalyst, Titanium Dioxide, is Used on Bleaching Process of External Teeth

In order to evaluate the whitening effect on bleaching agent in which both the PEA and titanium oxide are used, applicants have been taken the composition used in Control group 4, and then additionally included 0.00076 gram of PEA from Example 1. Afterward, the sample teeth are undergone the same procedures as used in Control group 3, and in which Example 9(a) is undergone light exposure, while Example 9(b) is undergone no light source. The bleaching time lasts for forth (40) minutes, and the results are entered in Table 4.

The results reveal that when both the titanium oxide of 1 wt % and 0.00076 grams of PEA are added into the hydrogen peroxide of 3.5 wt %, the color difference (ΛE) of Example 9(a) is 8.02±4.37, and which is apparently higher than color difference (ΔE) of Example 9(b), which is 3.13±1.96. In addition, under the same conditions, the bleaching agent, having PEA added, is far superior to the bleaching agent without PEA, see Control group 4(a), in which the color difference (Λn) is 4.51±2.54. This result is surprising and unexpected.

TABLE 4
Evaluation of whitening effect when the photocatalyst, titanium dioxide, used on
bleaching process of external teeth

| | Control group 4(a) | Control group 4(b) | Example 9(a) | Example 9(b) |
|---|---|---|---|---|
| Composition | | | | |
| H₂O₂(wt %) | 3.5 | 3.5 | 3.5 | 3.5 |
| H₂O₂ (g) | 10.14 | 10.14 | 10.14 | 10.14 |
| PF-127 (g) | 2 | 2 | 2 | 2 |
| TiO₂ (g) | 0.05 | 0.05 | 0.05 | 0.05 |
| FeO (g) | 0.10 | 0.10 | 0.10 | 0.10 |
| PEA (g) | | | 0.00076 | 0.00076 |
| Operating Conditions | | | | |
| Light Source | On | Off | On | Off |
| Bleaching Time (min) | 40 | 40 | 40 | 40 |
| Before Bleaching | | | | |
| X | 25.76 | 23.83 | 21.35 | 23.55 |
| Y | 26.29 | 24.07 | 21.61 | 23.83 |
| Z | 26.85 | 25.44 | 20.14 | 23.45 |
| After Bleaching | | | | |
| L* | 62.23 ± 2.53 | 57.26 ± 2.74 | 61.39 ± 4.31 | 58.29 ± 1.78 |
| a* | 0.53 ± 0.27 | 1.39 ± 0.50 | 0.29 ± 1.03 | 1.29 ± 0.27 |
| b* | 3.22 ± 0.76 | 3.10 ± 0.43 | 7.39 ± 1.04 | 4.67 ± 0.94 |
| Color DifferenceΔE* | 4.51 ± 2.54 | 2.65 ± 0.53 | 8.02 ± 4.37 | 3.13 ± 1.96 |

From the description and disclosure discussed above, the composition initiated by the present invention has achieved its intended objectives, and expresses its novelty, utility. Specially, clinically it demonstrates it can be effectively applied on the actual bleaching process, and brings about a superior result. In fact, the composition's effectiveness in bleaching capabilities is surprising and unexpected. It apparently meets the requirements of invention patent. While the present invention has been described in connection with the preferred embodiments of the various examples, it is to be understood that other similar embodiments may be used or modifications and additions may be made to the described embodiment for performing the same function of the present invention without deviating therefore. Therefore, the present invention should not be limited to any single embodiment, but rather construed in breadth and scope in accordance with the recitation of the appended claims.

We claim:

1. A dental bleaching system comprising a first component comprising a peroxide and a peroxide compatible gel compound; a second component comprising an anti-oxidant catalase and an anti-oxidant stabilizer; wherein said first and said second components are mixed.

2. The dental bleaching system of claim 1 wherein said anti-oxidant catalase is extracted from plant tubers.

3. The dental bleaching system of claim 1 having a pH about 8 or higher.

4. The dental bleaching system of claim 1 wherein a pH of said first component is between 7 to 11 and a pH of said second component is between 5 to 7.

5. The dental bleaching system of claim 1 wherein said peroxide is selected from a group consisting of a hydrogen peroxide, an organic peroxide, a compound which generates hydrogen peroxide, and combination thereof.

6. The dental bleaching system of claim 1, wherein said peroxide compatible compound gel is Pluronic F-127.

7. The dental bleaching system of claim 2, wherein said plant tubers is selected from a group consisting of potato, sweet potato, yam, taro and derivate species.

8. The dental bleaching system of claim 1 wherein said anti-oxidant catalase is a vegetative enzyme extracted from plant tubers.

9. The dental bleaching system of claim 8 wherein said vegetative enzymes extracted from plant tubers is a potato extract antioxidant.

10. The dental bleaching system of claim 8, wherein said plant tubers is selected from a group consisting of potato, sweet potato, yam, taro and derivate species.

11. The dental bleaching system of claim 1 wherein said anti-oxidant catalase stabilizer is selected from a group consisting of NaN3 (sodium azide), EDTA, EGTA, DTT (dithiothreitol), β-ME (β-Mercaptoethanol)), BSA (bovine serum albumin), (Tween-20, Triton X-100), Glycerol, glucose, urea, PMSF (phenylmethylsulfonyl fluoride), TPCK, TLCK and benzamidine; wherein said anti-oxidant catalase stabilizer is capable of stabilizing or maintaining activity of the enzymes.

12. A method to bleach mammal's teeth comprising:
a. providing a first component comprising a peroxide and a peroxide compatible gel compound;
b. providing a second component comprising an anti-oxidant catalase and an anti-oxidant stabilizer;
c. mixing said first component and said second component resulting a combined component;
d. applying said combined component to a mammal's teeth.

13. The method of claim 12 wherein said anti-oxidant catalase is extracted from plant tubers.

14. The method of claim 12 wherein said combined component has a pH of 8 or higher.

15. The method of claim 12 wherein said first component has a pH of between 7 to 11 and said second component has a pH of between 5 to 7.

16. The method of claim 12 wherein said anti-oxidant catalase is a vegetative enzyme extracted from plant tubers.

17. The method of claim 20 wherein said vegetative enzymes extracted from plant tubers is a potato extract antioxidant.

18. The method of claim 20 wherein said plant tubers is selected from a group consisting of potato, sweet potato, yam, taro and derivate species.

19. The method of claim 12 wherein said anti-oxidant catalase stabilizer is selected from a group consisting of NaN3 (sodium azide), EDTA, EGTA, DTT (dithiothreitol), β-ME (β-Mercaptoethanol)), BSA (bovine serum albumin), (Tween-20, Triton X-100), Glycerol, glucose, urea, PMSF (phenylmethylsulfonyl fluoride), TPCK, TLCK and benzamidine; wherein said anti-oxidant catalase stabilizer is capable of stabilizing or maintaining activity of the enzymes.

20. The method of claim 12 wherein said combined component is effective in removing extrinsic stains from said mammal's teeth.
